(19) United States
(12) Patent Application Publication
(10) Pub. No.: US 2006/0136685 A1
(43) Pub. Date: Jun. 22, 2006

(54) Method and system to maintain data consistency over an internet small computer system interface (iSCSI) network

(75) Inventors: Mor Griv, Tel Aviv (IL); Ronny Sayag, Tel Aviv (IL); Philip Derbeko, Jerusalem (IL)

Correspondence Address: KATTEN MUCHIN ROSENMAN LLP, 575 MADISON AVENUE, NEW YORK, NY, 10022-2585, US

(73) Assignee: SANRAD LTD.

(21) Appl. No.: 11/016,238

(22) Filed: Dec. 17, 2004

(51) Int. Cl. G06F 12/16

(52) U.S. Cl. 711/162; 709/216

(57) ABSTRACT

A method and system is disclosed to maintain data consistency over an internet small computer system interface (iSCSI) network, for disaster recovery and remote data replication purposes. Data consistency and replication is maintained between primary and secondary sites geographically distant from each other. According to the method, a primary journal volume logs all changes (data writes) made to a primary volume, transmits the changes based on a preconfigured policy to a secondary journal volume, and thereafter merges the changes stored in the secondary journal volume with a secondary volume. Changes in the journal volumes are ordered in point-in-time (PiT) frames and transmitted using a vendor specific SCSI command utilizing the iSCSI protocol.

### BACKGROUND OF THE INVENTION

1. Field of Invention

The present invention relates generally to disaster recovery and remote data replication in storage area networks (SANs), and more particularly to a system and method thereof for maintaining data consistency over an iSCSI network.

2. Discussion of Prior Art

Almost all business processing systems are concerned with maintaining backup data in order to ensure continued data processing when data is lost, damaged, or otherwise unreachable. Furthermore, business processing systems require data recovery in a case of unplanned interruption, also referred to as a “disaster”, of a primary storage site. Specifically, disaster recovery protection requires that at least a secondary copy of data is stored at a location remote to the primary site.

There are a myriad of prior-art disaster protection solutions. A known method of providing disaster protection is to backup data to a tape on a regular basis. The tape is then shipped to a secure storage area, usually located at a distance from the primary data center. A problem of this protection solution is the recovery time upon a disaster as it could take up to few days to restore the backup data, while at this time the data center can not operate.

An improved disaster recovery solution, also referred to as “remote mirroring”, is to backup data remotely and continuously, where the secondary site is geographically distant from the primary site. The two sites are typically connected to each other via high-speed wide area network (WAN) link. When data writes are made to a local volume at the primary site, these writes are replicated on a remote volume at the secondary site via the WAN link. This solution utilizes one of two different data replication methods referred to as synchronous mirroring or asynchronous mirroring.

In synchronous mirroring, data writes are simultaneously issued to both local and remote volumes. Write commands are placed in a holding queue while the host waits for the remote write to be completed and acknowledged. This method introduces substantial latency into the production environment even when the mirrored volumes share a high-speed connection. In asynchronous mirroring, data writes are made to the local volume and the host is acknowledged when local write is completed. The data writes are then transferred off-line to a remote site. This method reduces latency; however, it results in data gaps between the local and remote sites.

In storage area networks (SANs) data blocks are transferred between hosts and storage devices mainly by using the Fiber Channel (FC) or small computer system interface (SCSI) protocols. Traditionally, the connection to a remote SAN, for the purpose of disaster recovery, is formed through a FC link. This provides a native solution to backup data for distances of up to tens kilometers between a local and remote site. However, such a solution is expensive as it mandates a dedicated FC fiber-optic cable spread between the two sites. To eliminate the distance limitation, few technologies and protocols have been introduced. One of which is the internet FC protocol (iFCP) which provides a mechanism for transferring FC SCSI commands over IP networks. Yet, the iFCP solution requires dedicated and very expensive hardware for bridging between FC ports and the IP network. In addition, such hardware can bridge only a single FC port to the network, resulting in a bandwidth bottleneck.

Another connectivity means used in SANs is the internet SCSI (iSCSI) protocol. The iSCSI protocol utilizes the IP networking infrastructure to quickly transport large amounts of data blocks over existing local or wide area networks. The iSCSI does not require any dedicated hardware and does not have distance limitations. Therefore, there is a need for a system and method thereof that provides disaster recovery and remote data replication functionalities enabling to maintain data consistency between two SANs over an iSCSI network.

The following references provide a general teaching in the area of data coherency and data recovery, but they fail to provide for many of the limitations of the present invention.

The patent to Duyanovich et al. (U.S. Pat. No. 5,555,371) provides for data backup copying with delayed directory updating and reduced numbers of DASD accesses at a backup site using a log structured array data storage. Data storage in both primary and secondary data processing systems is provided by a log structured array (LSA) system that stores data in a compressed form. Each time data are updated within LSA, the updated data are stored in a data storage location different from the original data. Selected data recorded in a primary storage of the primary system is remote dual copied to the secondary system for congruent storage in a secondary storage device for disaster recovery purposes.

The patent to Kern et al. (U.S. Pat. No. 5,720,029) provides for a disaster recovery system for asynchronously shadowing record updates in a remote copy session using track arrays. A host processor at a primary site of the disaster recovery system transfers a sequentially consistent order of copies of record updates to a secondary site for backup purposes. The copied record updates are stored on the secondary data storage devices which form remote copy pairs with the primary data storage devices at the primary site.

The patent to Kern et al. (U.S. Pat. No. 5,734,818) provides for a remote data shadowing system forming consistency groups using self-describing record sets for remote data duplexing. Record updates at a primary site cause write I/O operations in a storage subsystem therein. The write I/O operations are time stamped and the time sequence and physical locations of the record updates are collected in a primary data mover.

The patent to Crockett et al. (U.S. Pat. No. 6,105,078) provides for an extended remote copying system for reporting both active and idle conditions wherein the idle condition indicates no updates to the system for a predetermined time period. A primary data mover monitors both consistency time and idle time in a system that performs continuous, asynchronous, extended remote copying between primary and remote processors, and manages both with accuracy and consistency. The primary data mover detects system activity levels and manages data accuracy for the extended remote copying in both active and idle systems.

The patent to LeCrone et al. (U.S. Pat. No. 6,543,001) provides for a method and apparatus for maintaining consistency data coherency in a data processing network including local and remote data storage controllers interconnected by independent paths. The remote storage controller(s) normally act as a mirror for the local storage controller(s), and, if transfer over one of the independent communication paths to predefined devices in a group is suspended thereby assuring data consistency at the remote storage controller(s). When the cause of the interruption has been corrected, the local storage controllers are able to transfer data modified since the last suspension occurred to their corresponding remote storage controllers to reestablish synchronism and consistency for the entire dataset.

The patent to Milillo et al. (U.S. Pat. No. 6,643,671) provides for a system and method for synchronizing a data copy using an accumulation remote copy trio consistency group. Target volumes transmit to secondary volumes in series relative to each other so that consistency is maintained at all times across the source volumes.

The patent application publication to Kodama et al. (US 2004/0133718) provides for a direct access storage system with combined block interface and file interface access, wherein the system includes a storage controller and storage media for reading data from or writing data to storage media in response to block-level and file-level I/O requests.

Whatever the precise merits, features, and advantages of the above cited references, none of them achieves or fulfills the purposes of the present invention.

### SUMMARY OF THE INVENTION

The present invention provides for a method for maintaining data consistency over an internet small computer system interface (iSCSI) network, for disaster recovery purposes, wherein the method comprises the steps of: (a) copying the entire content of a primary volume to a secondary volume; (b) receiving data writes from at least one host; (c) saving simultaneously the data writes in a primary volume and in the primary journal, wherein the data writes in the primary journal are ordered in point-in-time (PiT) frames; and (d) according to a predefined policy initiating a process for transferring at least one PiT frame from the primary journal to a secondary journal by inserting in the primary journal a PiT marker ending the PiT frame, iteratively, obtaining data writes saved in the PiT frame, generating for each data write to be transferred a small computer system interface (SCSI) command, transferring the SCSI command to a secondary site using the iSCSI protocol, and saving the data write encapsulated in the SCSI command in a secondary journal.

The present invention also provides for a system for maintaining data consistency over an internet small computer system interface (iSCSI) network, for disaster recovery purposes, wherein the system comprises: (a) a network interface capable of communicating with a plurality of hosts through a network; (b) a data transfer arbiter (DTA) capable of handling data writes transfer between a plurality of storage devices and the plurality of hosts; wherein the DTA is being further capable of controlling the process of maintaining data consistency; (c) a device manager (DM) capable of interfacing with the plurality of storage devices; and, (d) a journal transcriber capable of transferring data writes from a primary site to a secondary site.

The present invention also provides for a computer program product comprising a computer readable medium with instructions to enable a computer to implement a method maintaining data consistency over an internet small computer system interface (iSCSI) network, wherein the medium comprises: (a) computer readable program code working in conjunction with the computer to copy the entire content of a primary volume to a secondary volume; (b) computer readable program code working in conjunction with the computer to receive data writes from at least one host; (c) computer readable program code working in conjunction with the computer to save, simultaneously, the data writes in the primary volume and in a primary journal, wherein the data writes in the primary journal are ordered in point-in-time (PiT) frames; and (d) computer readable program code working in conjunction with the computer to initiate, according to a predefined policy, a process for transferring at least one PiT frame from the primary journal to a secondary journal by inserting in the primary journal a PiT marker ending the PiT frame, iteratively obtaining data writes saved in the PiT frame, generating for each data write to be transferred a small computer system interface (SCSI) command, transferring the SCSI command to a secondary site using the iSCSI protocol, and saving the data write encapsulated in the SCSI command in a secondary journal.

The present invention also provides for a computer program product comprising a computer readable medium with instructions to enable a computer to implement a method maintaining data consistency over an internet small computer system interface (iSCSI) network, wherein the medium comprises: (a) computer readable program code working in conjunction with the computer to insert a PiT marker beginning a PiT frame to be transferred; (b) computer readable program code working in conjunction with the computer to log data writes in a primary journal, wherein said data writes are ordered in the point-in-time (PiT) frame; (c) computer readable program code working in conjunction with the computer to insert a PiT marker indicating end of said PiT frame to be transferred; (d) iteratively obtaining data writes saved in said PiT frame; (e) computer readable program code working in conjunction with the computer to generate, for each data write to be transferred, a small computer system interface (SCSI) command; (f) computer readable program code working in conjunction with the computer to transfer said generated SCSI command to said secondary site using the iSCSI protocol; and (g) computer readable program code working in conjunction with the computer to save a data write encapsulated in the SCSI command in a secondary journal.

### BRIEF DESCRIPTION OF THE DRAWINGS

FIG. 1 illustrates an exemplary storage system used to describe the principles of the present invention.

FIG. 2 illustrates an exemplary diagram of volumes hierarchy used in performing the PiT based asynchronous mirroring.

FIG. 3 illustrates a non-limiting and exemplary functional block diagram of virtualization switch (VS) disclosed by this invention.

FIG. 4 illustrates a non-limiting flowchart describing the method for maintaining data consistency for disaster recovery purposes in accordance with an exemplary embodiment of this invention.

FIG. 5 illustrates a non-limiting flowchart describing the execution of the PiT synchronization procedure accordance with an exemplary embodiment of this invention.

FIG. 6 illustrates a non-limiting flowchart describing the merging procedure in accordance with an exemplary embodiment of this invention.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Disclosed are a method and system for maintaining data consistency over an Internet small computer system interface (iSCSI) network for disaster recovery purposes. Data consistency is maintained between primary and secondary sites geographically distant from each other. The method disclosed logs all changes (data writes) made to a primary volume in a primary journal, transmits the changes according to a predefined policy, to a secondary journal, and thereafter merges the changes in the secondary journal with a secondary volume. Changes logged in the primary journal are ordered in point-in-time (PiT) frames and transmitted using a vendor specific SCSI command utilizing the iSCSI protocol.

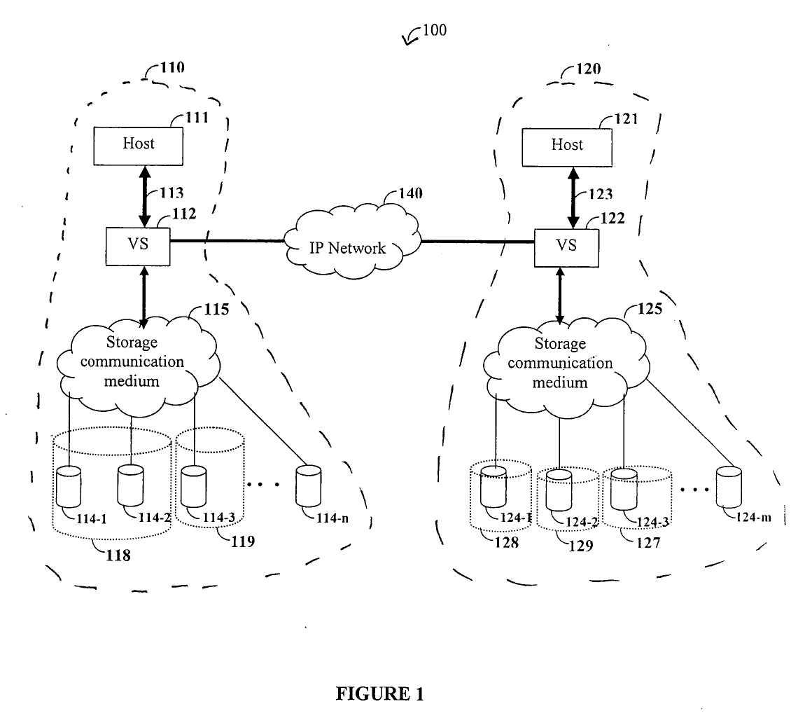

Referring to FIG. 1, an exemplary wide area storage network (WASN) 100 used to describe the principles of the present invention is shown. WASN 100 comprises two storage area networks (SANs) 110 and 120 connected through an IP network 140. SANs 110 and 120 are respectively considered as a primary site and a secondary site. SAN 110 includes a host 111 connected to a virtualization switch (VS) 112 through an Ethernet connection 113. VS 112 is connected to a plurality of storage devices 114 through a storage communication medium 115. Similarly, SAN 120 includes a host 121 connected to a VS 122 through an Ethernet connection 123, where VS 122 communicates with a plurality of storage devices 124 via a storage communication medium 125. Each storage communication medium 115 or 125 may be, but is not limited to, Fiber channel (FC) fabric switch, a small computer system interface (SCSI) bus, iSCSI and the like. It should be noted that each SAN can use a different type of storage communication, e.g., VS 112 may be connected to a storage device through a SCSI bus, while VS 122 may use a FC switch for the same purpose. It should be noted that a plurality of host computers connected in a local area network (LAN) may communicate with a virtualization switch.

Storage devices 114 and 124 are physical storage elements including, but not limited to, tape drives, optical drives, disks, and redundant array of independent disks (RAID). A virtual volume can be defined on one or more physical storage devices 114 and 124. Each virtual volume and hence storage device is addressable by logic unit (LU) identifier which usually comprises a target and a logical unit number (LUN). For the purpose of demonstrating the operation of the present invention a primary volume 118 comprising of storage devices 114-1 and 114-2 is defined in SAN 110 and exposed to host 111, while a secondary volume 128 comprising of storage device 124-1 is defined in SAN 120. The primary and secondary volumes are configured as a disaster recovery (DR) pair. A DR pair is a pair of volumes, one exposed on the primary site and the other exposed on the secondary site, where the latter volume is configured to be an asynchronous mirror volume of the former volume. It should be noted that a primary volume in the DR pair may be part of a consistency group. A consistency groLip is a groLip of volumes that maintain their consistency as a whole. All operations on volumes across a consistency group must be finished before any further action that may compromise the group consistency is performed.

The present invention discloses a point-in-time (PiT) based asynchronous mirroring technique for performing data replication for disaster recovery purposes. This technique provides a consistent recoverable volume at specific points in time. In accordance with the disclosed technique, primary volume 118 contains the updated data while secondary volume 128 contains a consistent copy of primary volume 118 at a specific point in time. Namely, the primary and secondary volumes have an intrinsic data gap.

To utilize the PiT based asynchronous mirroring technique a journal volume 119 (a primary journal) is linked to the primary volume 118 and another journal volume 129 (a secondary journal) is linked to the secondary volume 128. A journal may be considered as a first-in first-out (FIFO) queue where the first inserted record is the first to be removed from journal. Journaling is used intensively in database systems and in file systems. In such systems the journal logs any transactions or file system operations. The present invention utilizes the journal volumes to log data writes (changes) in storage devices. Specifically, journal volume 119 records data writes made to primary volume 118 and journal volume 128 maintains a copy of these writes that are up-to-date to a certain point in time. The data writes in the journal volumes are ordered in PiT frames. Each PiT frame includes a series of sequential writes perfonmed between two consecutive PiTs. The boundaries of a PiT frame are determined by a PiT marker that acts as a separator, and inserted by VS 112 each time a PiT synchronization procedure is called. This procedure is discussed in greater detail below. In an embodiment of this invention each of the journal volumes utilizes storage devices, e.g., disks. However, it should be noted that each of journal volumes 119 or 129 may be implemented using one or more non-volatile random access memory (NVRAM) units that may be connected to an uninterruptible power supply (not shown).

To ensure a proper recovery in a case of a disaster there is also a need to maintain the state of the primary site. For that purpose, VS 112 exchanges control information with VS 122 using a vendor specific SCSI command utilizing the iSCSI protocol.

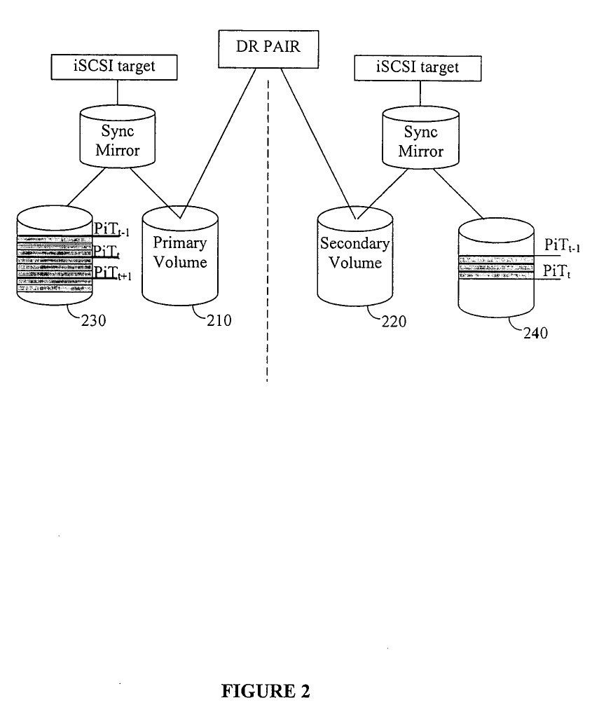

FIG. 2 illustrates an exemplary diagram of volumes hierarchy used for performing the PiT based asynchronous mirroring. The DR pair comprises a primary volume 210 that resides in a primary (local) site, and a secondary volume 220 that resides in a secondary (remote) site. PiT journal volumes 230 and 240 are attached to primary volume 210 and secondary volume 220, respectively. In an embodiment of this invention, primary volume 210 and journal volume 230 are configured as a synchronized mirror volume and exposed as a LU on an iSCSI target. Hence, each data block written to primary volume 210 is simultaneously saved in journal volume 230. Similarly, secondary volume 220 and secondary journal volume 240 are configured as a synchronized mirror volume and exposed as a LU on an iSCSI target. It should be noted that the secondary LU (i.e., the secondary journal and volume) is accessible by VS 112 only while replicating PiT frames.

In FIG. 2, journal volume 230 includes two PiT frames of data writes recorded during PiTt-1 to PiTt and PiTt to PiTt+1. Journal volume 240 includes only the changes recorded between PiTt-1 to PiTt (i.e., a single PiT frame) and were written to secondary volume 220. Therefore, there is a data gap of at least one PiT frame between the two volumes of the DR pair.

The process for maintaining data consistency begins with a replication of the entire content of primary volume 118 to secondary volume 128. This procedure is referred to as the “initial synchronization” and is further discussed below. Once those two volumes are synchronized, all data writes (i.e., changes from the initial state) are recorded in journal volume 119. According to a predefined policy, a PiT marker is inserted to journal volume 119 and the PiT frame including all data writes between the last and previous PiT markers are transmitted to journal volume 129. PiT frame entries are sent to the secondary site utilizing a vendor-specific SCSI commands using the iSCSI protocol as a transport protocol over the IP network 140. In the secondary site the replicated PiT frame in journal volume 129 is merged with secondary volume 128 according to a predefined policy.

The predefined policy determines when to synchronize PiT frames with the secondary site and when to merge the PiT frames into the secondary volume. Specifically, the policies define the actions needed to be performed, the actions schedule and the consistency group the actions should be performed on. A policy may be, but is not limited to, completion of the transmission of a PiT frame, a user command, a predefined number of PiT frames in journal 129, a predefined elapsed time from the last merge action, a predefined time interval, a predefined number of data writes in a PiT frame, a predefined number of PiT frames, a predefined amount of changes (e.g., MB, KB, etc.), to replicate changes at a specific hour, and so on.

In case of a disaster in the primary site, the data that resides at the secondary journal includes all the entries needed to maintain a consistent and recoverable volume state for a specific point in time. That is, the last PiT frame that was successfully merged or fully written to the secondary journal 129. If journal volume 129 includes PiT frames that have not been merged yet, the user may run a merging procedure to update the PiT frames into secondary volume 128. To enable host 122 to access the latest consistent data, secondary volume 128 has to be exposed on host 122.

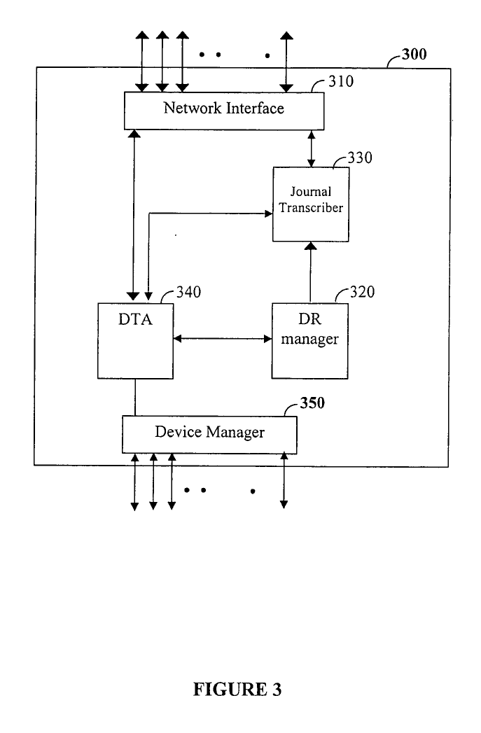

Referring to FIG. 3, a non-limiting and exemplary functional block diagram of VS 300 is shown. VS 300 executes the process of maintaining data consistency between the primary and secondary sites. VS 300 comprises a network interface (NI) 310, a disaster recovery (DR) manager 320, a journal transcriber 330, a data transfer arbiter (DTA) 340, and a device manger (DM) 350. DR manager 320 and journal transcriber 330 modules may function differently at each site. NI 310 interfaces between IP network (e.g., IP network 140), host computers and VS 300 through a plurality of input ports. DTA 340 performs the actual data transfer between the storage devices and the hosts and vice versa. Device manager 350 allows the interfacing with the storage devices through a plurality of output ports. The disaster recovery function is primarily executed, controlled, and managed by DR manager 320 and journal transcriber 330. DR manager 320 triggers the PiT synchronization procedure (when functioning at the primary site) and the merging PiT frames procedure (when functioning at the secondary site). These procedures are triggered according to a predefined set of policies mentioned in greater detail above. Journal transcriber 330, when acting at the primary site, mainly executes all activities related to reading the data write entries from the primary journal volume and transmitting them, using a vendor-specific SCSI command, to the secondary volume that forwards them directly to the journal volume. Furthermore, journal transcriber 330 on the secondary site, executes all activities related to merging the PiT frames into the secondary volume. It should be noted that only VS's 300 respective of disaster recovery functions are described herein. A detailed description of VS 300 is found in U.S. patent application Ser. No. 10/694,115 entitled “A Virtualization Switch and Method for Performing Virtualization in the Data-Path” assigned to common assignee and which is hereby incorporated in full by reference.

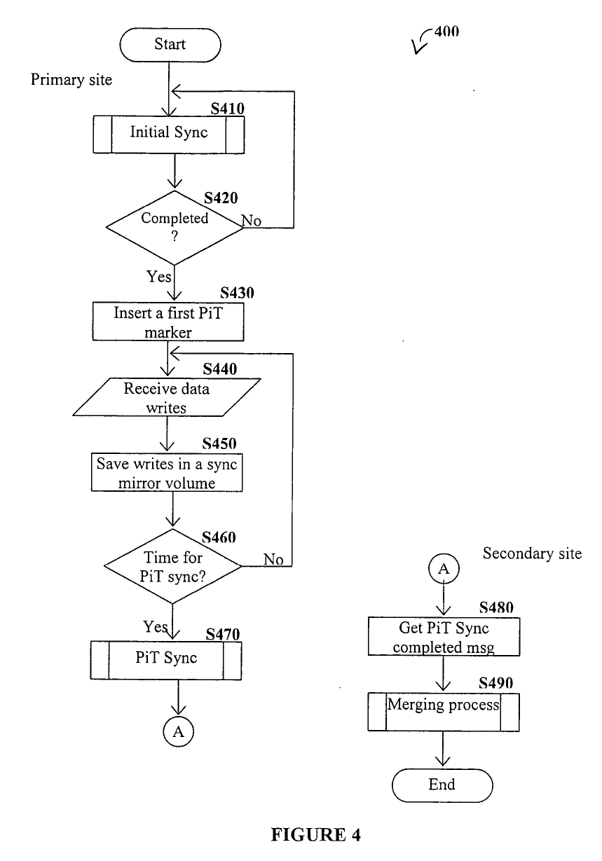

Referring to FIG. 4, a non-limiting flowchart 400 describing a method for maintaining data consistency for disaster recovery purposes is shown. The method discloses PiT based asynchronous mirroring between primary and secondary sites utilizing the iSCSI protocol. At step S410, the entire content of the primary volume, e.g., volume 118, is copied to the secondary volume, e.g., volume 128, through an initial synchronization procedure. This procedure may be either performed electronically or physically. The electronic process comprises duplicating the primary volume in its entirety by using electronic data transfers. The primary volume duplication can be done by using, for example, a block level replication. When using the electronic process for the initial synchronization the secondary volume, e.g., volume 128, has to be exposed on the VS of the primary site, e.g., VS 112. Another technique to perform the initial synchronization may involve taking a snapshot of the primary volume at a specific point in time and replicating a copy of the snapshot to the secondary volume. The physical process includes duplicating the primary volume locally at the primary site onto a storage medium, delivering the duplicated storage medium to the secondary site, and installing it there as the secondary volume. It should be noted that a person skilled in the art may be familiarized with other techniques for performing the initial synchronization. At step S420, a check is made to determine whether the initial synchronization process is completed, and if so execution continues with step S430; otherwise, execution returns to step S410. At step S430, a first PiT marker, e.g., PiT0, is inserted into the primary journal volume. The first PiT marker indicates that data writes made to the primary volume from that point in time must be saved also in the secondary volume. It should be noted that when a snapshot of the primary site is taken a first PiT marker is inserted into the journal volume as the snapshot copy is ready.

At step S440, data writes made by a client application that resides in the primary host (e.g., host 111) are received and thereafter, at step S450, written to the synchronous mirror volume. Namely, these writes are simultaneously written both to the primary volume and journal volume. Generally, the data writes saved in the journal volume include a data block and a logical block address (LBA) indicating the block location in the primary volume, e.g., an offset in the primary volume address space. At step S460, a check is made to determine whether the PiT synchronization procedure should be executed. As mentioned above, the execution of the PiT synchronization procedure is trigged by DR manager 320 according to predefined polices. If step S460 results with an affirmative answer execution continues with step S470 where the PIT synchronization procedure is performed; otherwise execution returns to step S440.

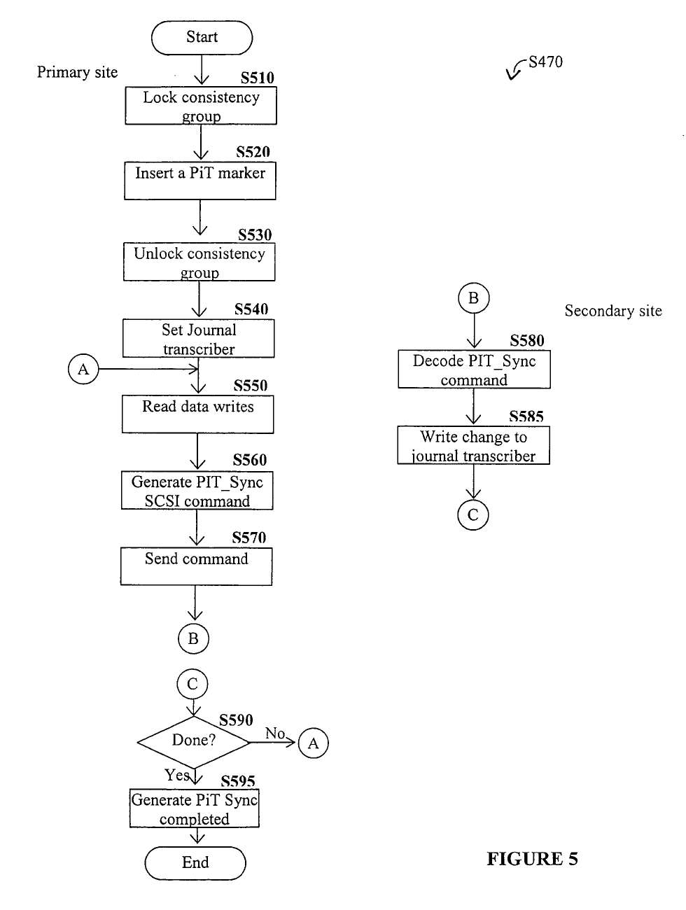

Referring now to FIG. 5, a non-limiting flowchart S470 describing the execution of the PiT synchronization procedure is shown. At step S510, once DR manager 320 triggers the PiT synchronization process, a consistency group including the primary volume is locked. Namely, any writes made to any volume in the consistency group after this particular point-in-time will be executed immediately after the insertion of a PiT marker. At step S520, a PiT marker, is inserted into the primary journal volume and thereafter, at step S530, the consistency group is unlocked. At step S540, DR manager 320 sets journal transcriber 330 with the specific PiT frame to be transmitted, the source journal volume to read the data writes (i.e., entries in a PiT frame) from, and the destination journal volume to write the data entries to. At step S550, a single data write, i.e., a data block and the LBA is retrieved from the source journal using a standard READ SCSI command. Each time execution reaches this step a different record in the specified PiT frame is retrieved to ensure that the entire frame is transmitted to the secondary site. At step S560, a vendor specific SCSI command (hereinafter the “PiT_Sync SCSI command”) is generated. The PiT_Sync SCSI command is a command that the VS at the secondary site can interpret. This SCSI command includes the retrieved data block in its data portion and the transfer length, as well as the LBA in its command descriptor block (CDB). At step S570, the PiT_Sync SCSI command is sent to the secondary site where the iSCSI is used as the transport protocol for that purpose. The command is addressed to the secondary volume with a LU identifier retrieved from the DR pair. At step S580, the VS at the secondary site receives the PiT_Sync command and decodes it. At step S585, the data block together with the LBA is saved in the secondary journal volume. At step S590, it is checked whether the entire PiT frame was transmitted to the secondary journal volume, and if so, at step S595 a “PiT sync completed” message is generated and sent to the secondary volume; otherwise, execution returns to step S550. Once the specified PiT frame is transferred to the secondary site, it can be deleted from the primary journal volume.

Referring back to FIG. 4, at step S480 the “PiT sync completed” message is received at the secondary VS, e.g., VS 122, and as a result at step S485 a check is made to determined if the merging procedure has to be executed, and if so, execution continues with step S490 where DR manager 320 triggers the execution of the merging procedure; otherwise, execution returns to step S480. The execution of the merging procedure is triggered by DR manager 320 based on the predefined policies discussed in greater detail above.

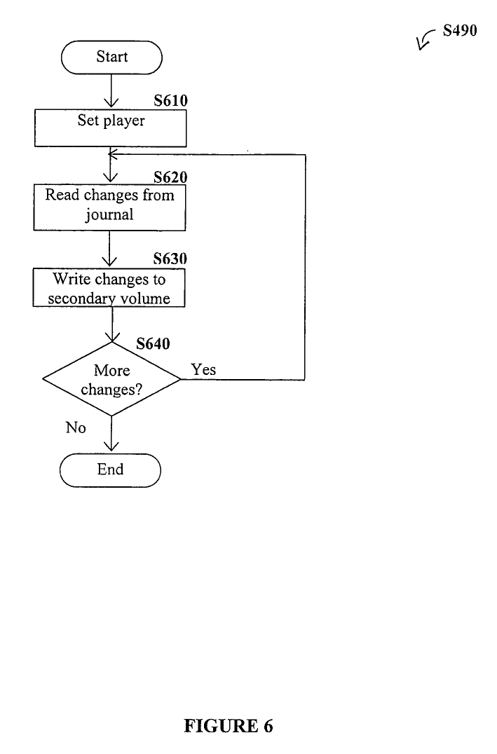

Referring to FIG. 6, a non-limiting flowchart S490 describing the merging procedure is shown. This procedure is executed at the secondary site by the VS, e.g., VS 122. At step S610, DR manager 320 activates journal transcriber 330 with the PiT frame to be merged, the journal volume as a source to read the changes from, and the secondary volume as a destination to write the changes to. At step S620, the first change, i.e., data block and its LBA in the specified PiT frame, is retrieved using a standard SCSI READ command. Each time execution reaches this step a different entry of the PiT frame is read from the source journal volume to ensure the entire frame is written to the secondary volume. At step S630, the retrieved data block is written to the secondary volume according to the location specified by the LBA, using a standard SCSI WRITE command. At step S640, a check is made to determine whether all the specified PiT frame journal entries were merged into the secondary volume, and if so, execution ends; otherwise, execution returns to step S620. Thereafter, the specified PiT frame may be removed from the secondary journal volume.

Additionally, the present invention provides for an article of manufacture comprising computer readable program code contained within implementing one or more modules implementing a method to maintain data consistency over an internet small computer system interface (iSCSI) network. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules for: (a) copying the entire content of a primary volume to a secondary volume; (b) receiving data writes from at least one host; (c) saving simultaneously the data writes in the primary volume and in a primary journal, wherein the data writes in the primary journal are ordered in point-in-time (PiT) frames; and (d) initiating, according to a predefined policy, a process for transferring at least one PiT frame from the primary journal to a secondary journal by inserting in the primary journal a PiT marker ending the PiT frame, iteratively obtaining data writes saved in the PiT frame, generating for each data write to be transferred a small computer system interface (SCSI) command, transferring the SCSI command to a secondary site using the ISCSI protocol, and saving the data write encapsulated in the SCSI command in a secondary journal.

Also implemented in a computer program code based products are software modules for: (a) inserting a PiT marker beginning a PiT frame to be transferred; (b) logging data writes in a primary journal, wherein said data writes are ordered in the point-in-time (PiT) frame; (c) inserting a PiT marker indicating end of said piT frame to be transferred; (d) iteratively obtaining data writes saved in said PiT frame; (e) generating, for each data write to be transferred, a small computer system interface (SCSI) command; (f) transferring said generated SCSI command to said secondary site using the iSCSI protocol; and (g) saving a data write encapsulated in the SCSI command in a secondary journal.

### CONCLUSION

A system and method has been shown in the above embodiments for the effective implementation of a method and system for maintaining data consistency over an internet small computer system interface (iSCSI) network. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of disaster recovery and remote data replication in storage area networks (SANs).

1. A method to transfer data writes from a primary site to a secondary site, for disaster recovery purposes, said method comprising:
inserting a PiT marker beginning a PiT frame to be transferred;
logging data writes in a primary journal, wherein said data writes are ordered in the point-in-time (PiT) frame;
inserting a PiT marker indicating end of said PiT frame to be transferred;
iteratively obtaining data writes saved in said PiT frame;
generating, for each data write to be transferred, a small computer system interface (SCSI) command;
transferring said generated SCSI command to said secondary site using the iSCSI protocol; and
saving a data write encapsulated in the SCSI command in a secondary journal.

2. A method to transfer data writes from a primary site to a secondary site, as per claim 1, wherein the PiT marker indicates a date and time of the PiT frame.

3. A method to transfer data writes from a primary site to a secondary site, as per claim 1, wherein said SCSI command is a vendor specific command.

4. A method to transfer data writes from a primary site to a secondary site, as per claim 1, wherein each of said data writes comprises at least a data block and a logical block address (LBA).

5. A method to transfer data writes from a primary site to a secondary site, as per claim 1, wherein said SCSI command comprises at least a data block and a logical block address (LBA) of a respective data write.

6. A method to transfer data writes from a primary site to a secondary site, as per claim 1, wherein said secondary site and said primary site are geographically distant from each other.

7. A method to transfer data writes from a primary site to a secondary site, as per claim 1, wherein said secondary site and said primary site communicate through at least an internet protocol (IP) network.

8. A method to transfer data writes from a primary site to a secondary site, as per claim 1, wherein said secondary site and said primary site are connected in a wide area storage network (WASN).

9. A method to transfer data writes from a primary site to a secondary site, as per claim 1, wherein said method further comprises the step of sending a control message signaling completion of PiT frame transmission.

10. A method to transfer data writes from a primary site to a secondary site, as per claim 1, wherein said method further comprises the step of deleting the PiT frame from said primary journal upon successful replication of content of said PiT frame.

11. A computer program product comprising a computer-readable medium with instructions to enable a computer to implement a process for transferring data writes from a primary site to a secondary site, for disaster recovery purposes, said medium comprising:
computer readable program code working in conjunction with a computer to insert a PiT marker beginning a PiT frame to be transferred;
computer readable program code working in conjunction with a computer to log data writes in a primary journal, wherein said data writes are ordered in the point-in-time (PiT) frame;
computer readable program code working in conjunction with a computer to insert a PiT marker indicating end of said PiT frame to be transferred;
computer readable program code working in conjunction with a computer to iteratively obtain data writes saved in said PiT frame;
computer readable program code working in conjunction with a computer to generate, for each data write to be transferred, a small computer system interface (SCSI) command;
computer readable program code working in conjunction with a computer to transfer said generated SCSI command to said secondary site using the ISCSI protocol; and
computer readable program code working in conjunction with a computer to save a data write encapsulated in the SCSI command in a secondary journal.

12. A computer program product comprising a computer-readable medium with instructions to enable a computer to implement a process for transferring data writes from a primary site to a secondary site, as per claim 11, wherein said PiT marker indicates a date and time of the PiT frame.

13. A computer program product comprising a computer-readable medium with instructions to enable a computer to implement a process for transferring data writes from a primary site to a secondary site, as per claim 11, wherein said SCSI command is a vendor specific command.

14. A computer program product comprising a computer-readable medium with instructions to enable a computer to implement a process for transferring data writes from a primary site to a secondary site, as per claim 11, wherein each data write comprises at least a data block and a logical block address (LBA).

15. A computer program product comprising a computer-readable medium with instructions to enable a computer to implement a process for transferring data writes from a primary site to a secondary site, as per claim 11, wherein said SCSI command comprises at least a data block and a logical block address (LBA) of a respective data write.

16. A computer program product comprising a computer-readable medium with instructions to enable a computer to implement a process for transferring data writes from a primary site to a secondary site, as per claim 11, wherein said medium further comprises computer readable program code working in conjunction with said computer to send a control message signaling the completion of PiT frame transmission.

17. A computer program product comprising a computer-readable medium with instructions to enable a computer to implement a process for transferring data writes from a primary site to a secondary site, as per claim 11, wherein said medium further comprises computer readable program code working in conjunction with said computer to delete the PiT frame from the primary journal upon transferring the entire content of the PiT frame.

18. A method to maintain data consistency over an internet small computer system interface (iSCSI) network, said method comprising:
copying content of a primary volume to a secondary volume;
receiving data writes from at least one host;
saving, simultaneously, said received data writes in a primary volume and in a primary journal, wherein said saved data writes in said primary journal are ordered in point-in-time (PiT) frames; and
initiating, according to a predefined policy, a transfer of at least one PiT frame from said primary journal to a secondary journal, said transfer comprising:
inserting a PiT marker in said primary journal, said PiT marker indicating end of said PiT frame;
iteratively obtaining data writes saved in said PiT frame;
generating, for each data write to be transferred, a small computer system interface (SCSI) command;
transferring said generated SCSI command to a secondary site via the iSCSI protocol; and
saving a data write encapsulated in said SCSI command in a secondary journal.

19. A method to maintain data consistency over an internet small computer system interface (iSCSI) network, as per claim 18, wherein the method further comprises the step of merging the PiT frames in the secondary journal with the content of the secondary volume.

20. A method to maintain data consistency over an internet small computer system interface (iSCSI) network, as per claim 19, wherein the step of merging the PiT frames further comprises the steps of:
iteratively obtaining each of said data writes in a specified PiT frame; and
saving each of said data write in said secondary volume.

21. A method to maintain data consistency over an internet small computer system interface (iSCSI) network, as per claim 20, wherein said step of obtaining data writes is performed using a read SCSI command.

22. A method to maintain data consistency over an internet small computer system interface (iSCSI) network, as per claim 20, wherein the step of saving the data writes is performed using a write SCSI command.

23. A method to maintain data consistency over an internet small computer system interface (iSCSI) network, as per claim 18, wherein each of the data writes comprises at least a data block and a logical block address (LBA).

24. A method to maintain data consistency over an internet small computer system interface (iSCSI) network, as per claim 18, wherein said SCSI command comprises at least a data block and a logical block address (LBA) of a respective data write.

25. A method to maintain data consistency over an internet small computer system interface (iSCSI) network, as per claim 24, wherein said step of saving said data write in said secondary volume further comprises saving a data block of said data write in a location designated by the LBA.

26. A method to maintain data consistency over an internet small computer system interface (iSCSI) network, as per claim 18, wherein said primary volume and said primary journal reside in a primary site.

27. A method to maintain data consistency over an internet small computer system interface (iSCSI) network, as per claim 26, wherein the secondary volume and the secondary journal reside in a a secondary site.

28. A method to maintain data consistency over an internet small computer system interface (iSCSI) network, as per claim 27, wherein said secondary site and said primary site are remotely located.

29. A method to maintain data consistency over an internet small computer system interface (iSCSI) network, as per claim 28, wherein said secondary site and said primary site communicate through at least an internet protocol (IP) network.

30. A method to maintain data consistency over an internet small computer system interface (iSCSI) network, as per claim 28, wherein said secondary site and said primary site are connected in a wide area storage network (WASN).

31. A method to maintain data consistency over an internet small computer system interface (iSCSI) network, as per claim 18, wherein said primary volume and said primary journal are defined as a mirror volume and exposed as a logical unit (LU) on an iSCSI target.

32. A method to maintain data consistency over an internet small computer system interface (iSCSI) network, as per claim 18, wherein said secondary volume and said secondary journal are defined as a mirror volume and exposed as a LU on an iSCSI target.

33. A method to maintain data consistency over an internet small computer system interface (iSCSI) network, as per claim 18, wherein said primary volume is part of a consistency group.

34. A method to maintain data consistency over an internet small computer system interface (iSCSI) network, as per claim 18, wherein said predefined policy is at least one of: a predefined time interval, a predefined number of data writes in a PiT frame, a predefined number of PiT frames, or a user command.

35. A method to maintain data consistency over an internet small computer system interface (iSCSI) network, as per claim 18, wherein said SCSI command for sending data writes is at least a vendor specific command.

36. A method to maintain data consistency over an internet small computer system interface (iSCSI) network, as per claim 18, wherein each of said primary journal and said secondary journal comprises at least one non-volatile random access memory (NVRAM) unit.

37. A method to maintain data consistency over an internet small computer system interface (iSCSI) network, as per claim 18, wherein aid method further comprises the step of sending a control message signaling the completion of the PiT frame transmission.

38. A method to maintain data consistency over an internet small computer system interface (iSCSI) network, as per claim 37, wherein said method further comprises the step of deleting a PiT frame from said primary journal upon transferring the content of said PiT frame.

39. A method to maintain data consistency over an internet small computer system interface (iSCSI) network, as per claim 18, wherein said PiT marker indicates a date and time of said PiT frame.

40. A computer program product comprising a computer-readable medium with instructions to enable a computer to implement a method maintaining data consistency over an internet small computer system interface (iSCSI) network, said medium comprising:
computer readable program code working in conjunction with said computer to copy content of a primary volume to a secondary volume;
computer readable program code working in conjunction with said computer to receive data writes from at least one host;
computer readable program code working in conjunction with said computer to save, simultaneously, said received data writes in a primary volume and in a primary journal, wherein said saved data writes in said primary journal are ordered in point-in-time (PiT) frames; and
computer readable program code working in conjunction with said computer to initiate, according to a predefined policy, a transfer of at least one PiT frame from said primary journal to a secondary journal, said transfer comprising:
inserting a PiT marker in said primary journal, said PiT marker indicating end of said PiT frame;
iteratively obtaining data writes saved in said PiT frame;
generating, for each data write to be transferred, a small computer system interface (SCSI) command;
transferring said generated SCSI command to a secondary site via the iSCSI protocol; and
saving a data write encapsulated in said SCSI command in a secondary journal.

41. A computer program product comprising a computer-readable medium with instructions to enable a computer to implement a method maintaining data consistency over an internet small computer system interface (iSCSI) network, as per claim 40, wherein medium further comprising computer readable program code working in conjunction with said computer to merge PiT frames in said secondary journal with the content of the secondary volume.

42. A computer program product comprising a computer-readable medium with instructions to enable a computer to implement a method maintaining data consistency over an internet small computer system interface (iSCSI) network, as per claim 41, wherein said medium further comprises:
computer readable program code working conjunction with said computer to iteratively, obtaining each of said data writes in a specified PiT frame; and
computer readable program code working conjunction with said computer to save each data write in said secondary volume.

43. A computer program product comprising a computer-readable medium with instructions to enable a computer to implement a method maintaining data consistency over an internet small computer system interface (iSCSI) network, as per claim 40, wherein each of said data writes comprises at least a data block and a logical block address (LBA).

44. A computer program product comprising a computer-readable medium with instructions to enable a computer to implement a method maintaining data consistency over an internet small computer system interface (iSCSI) network, as per claim 43, wherein the SCSI command comprises at least a data block and a logical block address (LBA) of a respective data write.

45. A computer program product comprising a computer-readable medium with instructions to enable a computer to implement a method maintaining data consistency over an internet small computer system interface (iSCSI) network, as per claim 42, wherein medium further comprises computer readable program code working in conjunction with said computer to save a data block of the data write in a location designated by the LBA.

46. A computer program product comprising a computer-readable medium with instructions to enable a computer to implement a method maintaining data consistency over an internet small computer system interface (iSCSI) network, as per claim 40, wherein said predefined policy is at least one of: a predefined time interval, a predefined number of data writes in a PiT frame, a predefined number of PiT frames, or a user command.

47. A computer program product comprising a computer-readable medium with instructions to enable a computer to implement a method maintaining data consistency over an internet small computer system interface (iSCSI) network, as per claim 42, wherein said data writes are performed using a read SCSI command.

48. A computer program product comprising a computer-readable medium with instructions to enable a computer to implement a method maintaining data consistency over an internet small computer system interface (iSCSI) network, as per claim 42, wherein said data writes are performed using a write SCSI command.

49. A computer program product comprising a computer-readable medium with instructions to enable a computer to implement a method maintaining data consistency over an internet small computer system interface (iSCSI) network, as per claim 40, wherein the SCSI command used for sending data writes is at least a vendor specific command.

50. A computer program product comprising a computer-readable medium with instructions to enable a computer to implement a method maintaining data consistency over an internet small computer system interface (iSCSI) network, as per claim 40, wherein said medium further comprises computer readable program code working in conjunction with a computer to send a control message signaling completion of PiT frame transmission.

51. A computer program product comprising a computer-readable medium with instructions to enable a computer to implement a method maintaining data consistency over an internet small computer system interface (iSCSI) network, as per claim 40, wherein medium further comprises computer readable program code working in conjunction with said computer to deleting a PiT frame from said primary journal upon transferring content of said PiT frame.

52. A computer program product comprising a computer-readable medium with instructions to enable a computer to implement a method maintaining data consistency over an internet small computer system interface (iSCSI) network, as per claim 40, wherein said PiT marker indicates a date and time of the PiT frame.

53. A system for maintaining data consistency over an internet small computer system interface (iSCSI) network, the system comprises at least:
a network interface communicating with a plurality of hosts through a network;
a data transfer arbiter (DTA) handling data writes transfer between a plurality of storage devices and the plurality of hosts; wherein said DTA further controls the process of maintaining data consistency;
a device manager (DM) interfacing with the plurality of storage devices; and
a journal transcriber transferring data writes from a primary site to a secondary site.

54. A system for maintaining data consistency over an internet small computer system interface (iSCSI) network, as per claim 53, wherein said primary site comprises at least a primary volume and a primary journal.

55. A system for maintaining data consistency over an internet small computer system interface (iSCSI) network, as per claim 54, wherein said primary volume and said primary journal are defined as a mirror volume and exposed as a logical unit (LU) on an iSCSI target.

56. A system for maintaining data consistency over an internet small computer system interface (iSCSI) network, as per claim 54, wherein said secondary site comprises at least a secondary volume and a secondary journal.

57. A system for maintaining data consistency over an internet small computer system interface (iSCSI) network, as per claim 56, wherein said secondary volume and said secondary journal are defined as a mirror volume and exposed as a LU on an iSCSI target.

58. A system for maintaining data consistency over an internet small computer system interface (iSCSI) network, as per claim 56, wherein said secondary site and said primary site are geographically distant from each other.

59. A system for maintaining data consistency over an internet small computer system interface (iSCSI) network, as per claim 56, wherein said secondary site and said primary site are connected in a wide area storage network (WASN).

60. A system for maintaining data consistency over an internet small computer system interface (iSCSI) network, as per claim 53, wherein said network is at least a local area network (LAN), a wide area network (WAN), an internet protocol (IP) network.

61. A system for maintaining data consistency over an internet small computer system interface (iSCSI) network, as per claim 53, wherein said process for maintaining data consistency comprises: copying the entire content of a primary volume to a secondary volume, inserting a first point-in-time (PiT) marker in a primary journal, receiving data writes from the plurality of hosts, saving simultaneously data writes in said primary volume and in said primary journal, wherein said data writes in said primary journal are ordered in PiT frames; and initiating, according to a predefined policy, a process to transfer at least one PiT frame to said secondary site.

62. A system for maintaining data consistency over an internet small computer system interface (iSCSI) network, as per claim 61, wherein said transfer of said PiT frame comprises inserting in said primary journal a PiT marker ending the PiT frame, iteratively obtaining data writes saved in the PiT frame, generating, for each data write to be transferred, a small computer system interface (SCSI) command, sending the SCSI command to the secondary site using the iSCSI protocol, and saving a data write encapsulated in the SCSI command in said secondary journal.

63. A system for maintaining data consistency over an internet small computer system interface (iSCSI) network, as per claim 62, wherein said transfer further comprises sending a control message signaling the completion of the PiT frame transmission.

64. A system for maintaining data consistency over an internet small computer system interface (iSCSI) network, as per claim 62, wherein said SCSI command used for sending data writes is at least a vendor specific command.

65. A system for maintaining data consistency over an internet small computer system interface (iSCSI) network, as per claim 62, wherein said journal transcriber merges content of said PiT frames in said secondary journal with content of said secondary volume.

66. A system for maintaining data consistency over an internet small computer system interface (iSCSI) network, as per claim 56, wherein each of said primary journal and said secondary journal comprises at least one non-volatile random access memory (NVRAM) unit.

67. A system for maintaining data consistency over an internet small computer system interface (iSCSI) network, as per claim 56, wherein each of the primary volume and the secondary volume is defined on one or more of the storage devices.

68. A system for maintaining data consistency over an internet small computer system interface (iSCSI) network, as per claim 67, wherein said storage devices are any of the following: a tape drive, optical drive, disk, sub-disk, or redundant array of independent disks (RAID).

69. A system for maintaining data consistency over an internet small computer system interface (iSCSI) network, as per claim 61, wherein said PiT marker indicates a date and time of the PiT frame.
